(19) United States
(12) Patent Application Publication
(10) Pub. No.: US 2010/0245817 A1
(43) Pub. Date: Sep. 30, 2010

(54) Microsphere Having Hot Spots and Method for Identifying Chemicals Through Surface Enhanced Raman Scattering Using the Same

(75) Inventors: Se Jin PARK, Song-pa Gu (KR); Taek Dong Chung, Gwa-cheon (KR); Lilin Piao, Gwanak Gu (KR); Han Kil Boo, Jung Gu (KR)

Correspondence Address: Wheelock Chan LLP, 2880 Zanker Road, Suite 109, San Jose, CA, 95134, US

(73) Assignee: Cubiq, Inc.

(21) Appl. No.: 12/750,648

(22) Filed: Mar. 30, 2010

(30) Foreign Application Priority Data
Mar. 31, 2009 (KR) 10-2009-0027800

(51) Int. Cl. G01J 3/44

(52) U.S. Cl. 356/301; 977/954

(57) ABSTRACT

The present invention relates to the microsphere whose surface is covered with hot spots and the method for identifying chemicals through Surface Enhanced Raman Scattering (SERS) using the same. The microsphere having hot spots, according to the present invention, includes a microsphere and metal networks as a shell which covers the surface of the microsphere, and nano-sized pores are distributed randomly on the surface or in the interstitial space of the metal networks. The microsphere having hot spots, according to the present invention, can be individually manipulated under a conventional optical microscope. SERS spectra of the monolayer of molecules on Pt or Au can be measured using single microsphere having hot spots mentioned as a sensitive probe. The microsphere having hot spots can be applied for decoding the microspheres with Raman tags flowing in a microfluidic system.

### RELATED APPLICATIONS

This application is related to and claims the benefit under 35 U.S.C. 119 to the Korean patent application bearing serial number 10-2009-0027800, entitled “Microsphere Having Hot Spots and Method For Identifying Chemicals Through Surface Enhanced Raman Scattering Using the Same”, filed Mar. 31, 2009. The content of the Korean patent application 10-2009-0027800 is incorporated herein in its entirety by reference.

### TECHNICAL FIELD

The present invention relates to the microsphere whose surface is covered with hot spots and the method for identifying chemicals through surface enhanced Raman scattering (SERS) using the same.

### BACKGROUND OF THE INVENTION

Surface-Enhanced Raman Scattering (SERS) has been a subject of intensive research since it suggests many useful applications such as biological sensing and trace analysis (Haynes, C. L.; McFarland, A. D.; Van Duyne, R. P. Anal. Chem. 2005, 77, 338A-346A). The unique signal enhancement of SERS reportedly allows the detection of analytes even at the single-molecule level. The huge enhancement in SERS process is known to occur at the so-called “hot spots”, which originate from either interstitial sites or the surface of nano-sized materials. Moskovits et al. proposed a simple strategy for creating SERS hot spots among closely spaced nanowires and showed that the enhancement is a function of interstitial distances (Lee, S. J.; Morrill, A. R.; Moskovits, M. J. Am. Chem. Soc. 2006, 128, 2200-2201). They also demonstrated a chemically patterned SERS-active system where the hot spots are easily found and analyzed (Braun, G.; Pavel, I.; Morrill, A. R.; Seferos, D. S.; Bazan, G. C.; Reich, N. O.; Moskovits, M. J. Am. Chem. Soc. 2007, 129, 7760-7761).

Electrochemically roughened metal surfaces and colloidal nanoparticles are traditionally employed as SERS substrates (Haynes, C. L.; McFarland, A. D.; Van Duyne, R. P. Anal. Chem. 2005, 77, 338A-346A). Recently more stable and controllable SERS-active substrates are reported including nanoparticle arrays fabricated with nanosphere lithography (Haynes, C. L.; Van Duyne, R. P. J. Phys. Chem. C 2003, 107, 7426-7433), nanowire bundles (Lee, S. J.; Morrill, A. R.; Moskovits, M. J. Am. Chem. Soc. 2006, 128, 2200-2201), and metal surfaces by templated electrodeposition (Abdelsalam, M. E.; Bartlett, P. N.; Baumberg, J. J.; Cintra, S.; Kelf, T. A.; Russell, A. E. Electrochem. Commun. 2005, 7, 740-744). On the other hand, tip-enhanced Raman scattering (TERS) has received extensive attention since it can provide a high spatial resolution as well as specific chemical information (Baldelli, S. Chemphyschem 2008, 9, 2291-2298). However, TERS at the present stage requires highly sophisticated setups and suffers from low signal enhancement, poor reproducibility, and difficulty in working in aqueous media. Halas et al. proposed a somewhat different approach, where a nanoshell geometry consisting of a dielectric core with a thin gold coating is utilized as SERS-active substrates (Oldenburg, S. J.; Westcott, S. L.; Averitt, R. D.; Halas, N. J. J. Chem. Phys. 1999, 111, 4729-4735). The use of an individual nanoshell as a SERS probe may provide a simple and efficient method to identify the molecules on a SERS-inactive substrate, which has been one of the challenging issues in current surface analysis. Another valuable application of an individual SERS-active particle in modern bioanalysis is a multiplex assay based on the respectively bar-coded microspheres with combination of SERS tags flowing in micro fluidic channels (Jun, B. H.; Kim, J. H.; Park, H.; Kim, J. S.; Yu, K. N.; Lee, S. M.; Choi, H.; Kwak, S. Y.; Kim, Y. K.; Jeong, D. H.; Cho, M. H.; Lee, Y. S. J. Comb. Chem. 2007, 9, 237-244; Jin, R. C.; Cao, Y. C.; Thaxton, C. S.; Mirkin, C. A. Small 2006, 2, 375-380). This strategy increasingly attracts keen attention from the viewpoint of acquisition more information in a smaller volume of sample within a shorter time. However, SERS signals from an individual nanoshell are too weak to be utilized for both surface probing and multiplex analysis. Moreover, the nanoshells are too small to be recognized by a conventional optical microscopy and thus hard to be individually addressed and manipulated.

### SUMMARY

According to embodiments of the present invention, it is reported that the microsphere with SERS-active Au shell, SERS signals from which are maximized. The microsphere proposed in the present invention has the size dimension that can be recognized by a conventional optical microscope. The microsphere proposed in the present invention suggests opportunities not only for sensitive surface probing and imaging of an organic molecule monolayer but also for multiplex assay based on bar coded microspheres using SERS techniques.

According to an embodiment of the present invention, an exemplary microsphere that has hot spots is provided and includes a microsphere and metal networks as a shell which covers the surface of the microsphere. Nano-sized pores are distributed randomly on the surface or in the interstitial space of the metal networks. The metal networks are formed with nanoparticles of SERS-active metals. For example, the metal networks are formed with SERS-active metals such as gold, silver, platinum and copper.

According to yet another embodiment of the present invention, another exemplary microsphere having hot spots is provided that has nano-size pores which are distributed randomly on the surface or in the interstitial space of the metal networks, where the size of pores is in the range of 1-30 nm, more desirably between 1-20 nm, and most desirably between 1-10 nm.

According to yet another embodiment of the present invention, a method for identifying chemicals through Surface-Enhanced Raman Scattering (SERS) is provided using the microsphere, where the method includes the following process of adsorption of analyte on the microsphere, generation of SERS signals from the microsphere on which the analyte is adsorbed, collection of the SERS signals, analysis of the SERS signals, and identification of the analyte.

According to embodiments of the present invention, the microsphere having hot spots and the SERS method using the same, provide the solution which can overcome the weakness of existing SERS method using nanoparticles. The microsphere having hot spots provides an advantage of easy manipulation whereas existing SERS methods using nanoparticles have difficulty in handling nanoparticles.

In addition, the microsphere having hot spots provides another advantage of being monitored through an optical microscope. Using a typical micropipette or optical tweezers, a single microsphere may be precisely placed on the targeted spot, trans-located to another spot and removed from the surface under the naked eye monitoring through an optical microscope.

Since the SERS activity of the microsphere having hot spots is stable in water, this system can be utilized for in situ surface chemical probing in aqueous phase, which is especially important for most of electro catalysis studies.

The microsphere having hot spots offers new opportunities for SERS-based probing techniques to a wide range of valuable applications such as a universal and reliable way of chemical identification with a high spatial resolution on surfaces, in vivo chemical or biological monitoring on the membrane of a living cell like neuron or stem cell, and high throughput decoding of microsphere suspension arrays in micro fluidic systems.

### BRIEF DESCRIPTION OF THE DRAWINGS

FIG. 1 is the graph that shows the SERS activities of microsphere with gold networks (MS-AuNets) on which 4-nitrobenzenethiol (NBT) is adsorbed. FIG. 1(a) shows normalized SERS intensities as a function of the number of Au plating. Insets show cross-sectional transmission electron microscope (TEM) images of MS-AuNets with different number of plating (bar: 100 nm). FIG. 1(b) shows SERS spectra from a single MS-AuNet modified with NBT. Inset shows an optical microscopic image of MS-AuNets scattered on a slide glass.

FIG. 2 shows SERS induced by a single bare MS-AuNet. FIG. 2(a) shows schematics for SERS-induced interfaces. FIG. 2(b) shows optical images of MS-AuNets on Au or Pt substrates. Laser probe is indicated by arrows. FIG. 2(c) shows SERS spectra from a NBT monolayer on an Au (green lines) and Pt (blue lines) substrates. Acquisition time was 1 second.

FIG. 3 shows TEM images of MS-AuNets after plating 10 times in FIG. 1.

FIG. 4 is schematic diagram that describes a method for identification of analyte by SERS using the microsphere having hot spots. The orange-colored microsphere stands for the microsphere which hot spots are formed on.

FIG. 5 shows scanning electron microscope (SEM) image of microsphere with silver networks (MS-AgNets), on which metal networks is formed with silver instead of gold, according to another embodiment.

FIG. 6 shows the spectrum of SERS that measured with 4-aminebenzenethiol-adsorbed MS-AgNets in FIG. 5.

### DESCRIPTION OF THE EMBODIMENTS

According to embodiments of the present invention, the microsphere having hot spots includes A) a microsphere and B) metal networks as a shell which covers the surface of the microsphere, and nano-sized pores are distributed randomly on the surface or in the interstitial space of the above metal networks.

The above microspheres can be synthesized with various materials and can be even synthesized with SERS-inactive materials. For example, microspheres include a polymer sphere of micro size, a metal particle of micro size, a silica particle of micro size, and a magnetic polymer sphere of micro size. In the embodiment of present invention, micro size means 1-1000 μm, more desirably 1-100 nm, and most desirably 1-30 nm.

The shell of metal networks is formed on the surface of the above microsphere, where the above metal networks are made of nanoparticles of SERS-active metals. Desirably, the above metal networks are made of nanoparticles of SERS-active metal such as gold, silver, platinum and copper. Nano-sized pores are distributed randomly on the surface or in the interstitial space of the above metal networks and they create hot spots. For example, the above metal networks can be formed by nanoparticles of 3-30 nm.

The size of pores which are distributed randomly on the surface or in the interstitial space of the above metal networks is 1-30 nm, more desirably 1-20 nm, and most desirably 1-10 nm.

According to embodiments of the present invention, the microsphere having hot spots is useful for identification of chemicals by Surface-Enhanced Raman Scattering (SERS). The above method includes adsorption of analyte on the microsphere, generation of SERS signals from the microsphere on which the analyte is adsorbed, collection of the SERS signals, analysis of the SERS signals, and identification of the above analyte.

In the following, examples further illustrate the structures and methods of this invention.

Microspheres with metal network structures (MS-MeNet) can be prepared by modification of established methods. Microspheres with Au network structures (MS-AuNet) are prepared based on procedures for Au nanoshells. Amine-terminated polystyrene spheres (d=10.8 μm) are decorated with Au nanoparticles (AuNPs) to provide nucleation sites, which are subsequently grown by electroless plating. The plating steps are repeated to gradually increase the size of Au nanoparticles on the microsphere surface.

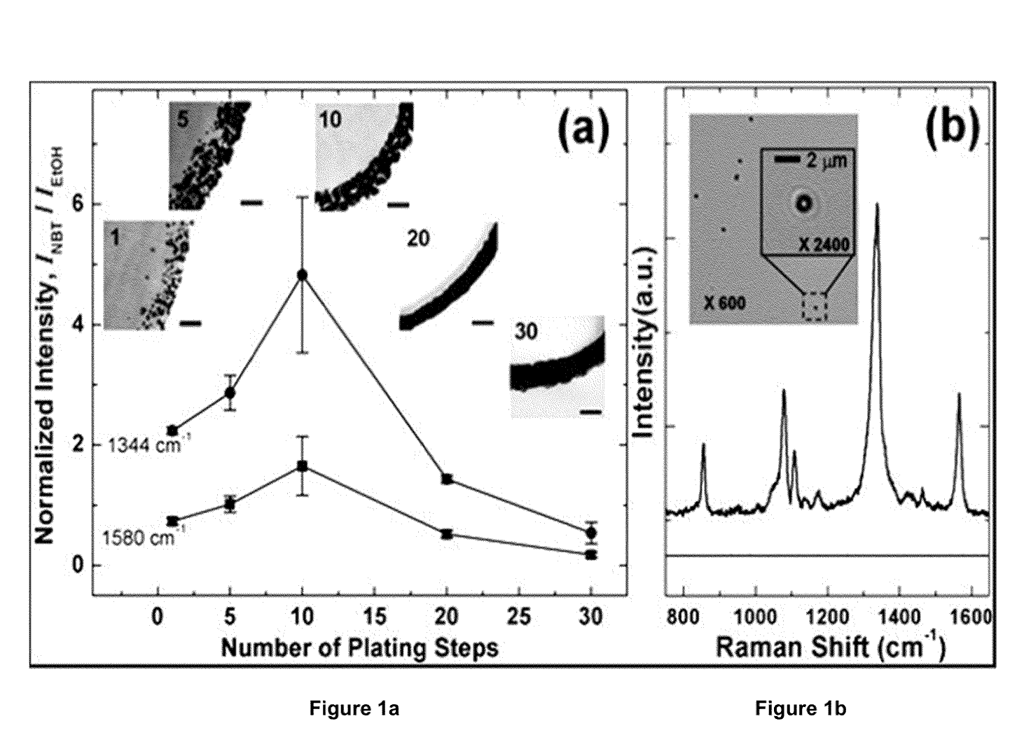

The SERS activity from MS-AuNets modified with 4-nitrobenzenethiol (NBT) as a function of the number of repetitive electroless plating is examined and the result is summarized in FIG. 1. No SERS intensity is observed from NBT on polystyrene spheres covered only with AuNP seed layers. As the Au layer grows, SERS peaks from NBT molecules on MS-AuNets start to grow and the peak positions are in good agreement with those obtained from NBT in a liquid phase. The enhancement of the SERS signals sensitively varies with the number of plating. FIG. 1 (a) shows that the intensities of 1344 cm⁻¹ and 1580 cm⁻¹ band from NBT normalized with respect to a characteristic ethanol band (833 cm⁻¹) versus the extent of plating. Ten times of plating produce a maximum SERS intensity, while further Au plating steps results in a rapid decrease of SERS intensity. The peaks from NBT almost disappear upon 30 times of plating.

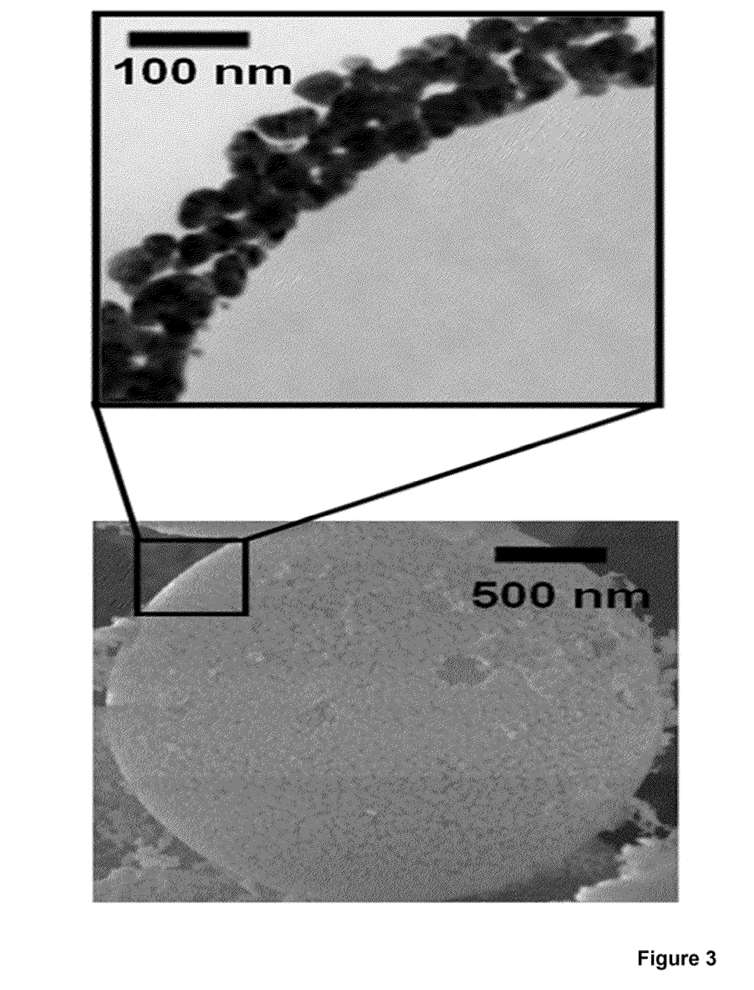

FIG. 1(a) also shows the cross sectional TEM images of MS-AuNets, which rationalize the dependence of SERS activity on the number of plating steps. The inter-particle distances among the AuNPs of the seed layer on a polystyrene sphere may be too large to create effective hot spots. A similar result was previously reported that SERS activities from individual AuNPs fixed on a flat silicon wafer surface are negligible until the inter-particle distance becomes sufficiently small and the inter-particle coupling progresses to some degree. As the number of gold plating increases to 5-10 times, gold nanoparticles grow into larger particles of about 20 nm and a part of them merge each other. The enhancement of SERS signals implies that the nanopores act as SERS-active hot spots. In other words, it is implied that the increase of gold plating to 5-10 times make the nanopores on the surface or in the interstitial place of gold networks and they create hot spots. The maximum enhancement of SERS peaks is shown when gold plating is repeated 10 times. As identified in the TEM image (the inset of gold plating for 10 times and FIG. 3), nanopores below tens of nanometers are distributed randomly on the surface or in the interstitial space of the metal networks. Meanwhile, SERS activity is not shown when gold plating is repeated more than 20 times. The TEM image for the repetition of gold plating more than 20 times (the inset of FIG. 1(a) for gold plating of 20 and 30 times) shows that the gold shell covered the polymer sphere completely. It means that the perfect gold shell without the structure of gold nano-network including many pores loses SERS activity. This behavior shows a wide difference compared with the fact that SERS activity is maximized when gold shell is formed almost completely.

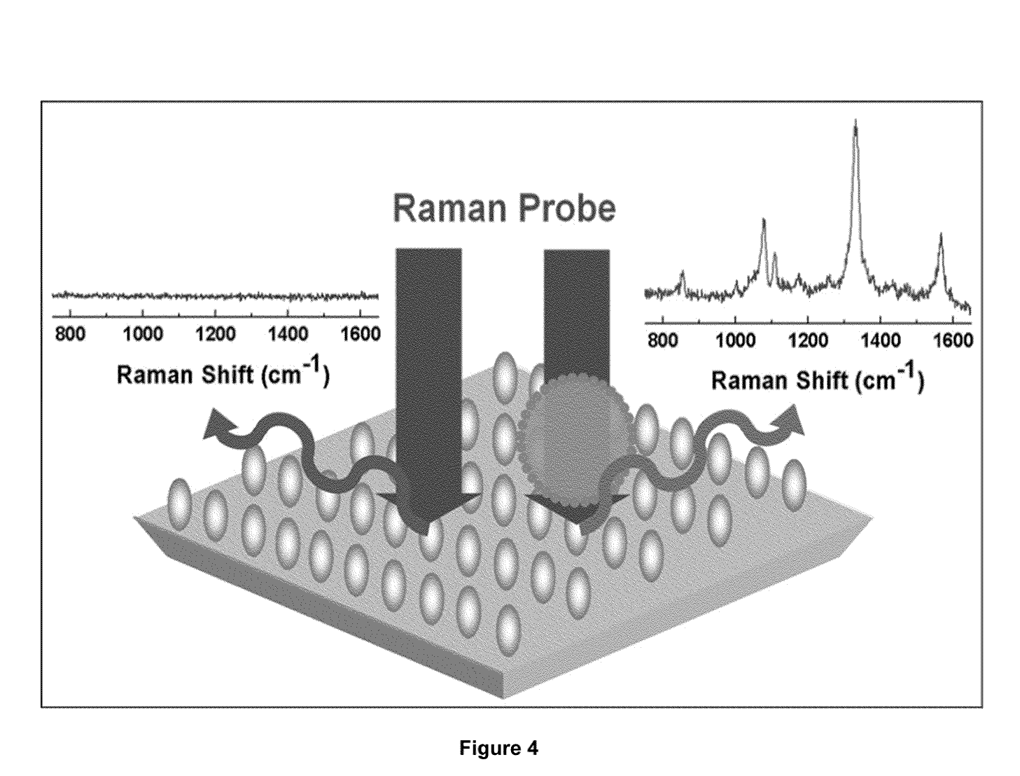

The MS-AuNets modified with NBT shows stable and reproducible SERS activities when re-dispersed in pure ethanol or water, where the SERS signals exhibit the same dependence on the extent of plating. NBT-modified MS-AuNets on a glass slide are recognized through a conventional optical microscope (FIG. 1(b), inset) and a laser beam can be focused on the center of a single MS-AuNet to obtain SERS spectra. FIG. 4 is schematic diagram that describes a method for identification of analyte by SERS using the microsphere having hot spots. SERS signals from a single MS-AuNet are strong enough to produce well defined spectra even for 1 ms of acquisition time. In addition, MS-AuNets modified with different thiolated derivatives can be individually addressed and identified. These are favorable features for the applications of SERS-based barcode readings, potentially in microfluidic systems. The reproducible SERS activity of a single MS-AuNet is confirmed by carrying out multiple measurements with more than 100 different NBT-modified MS-AuNets.

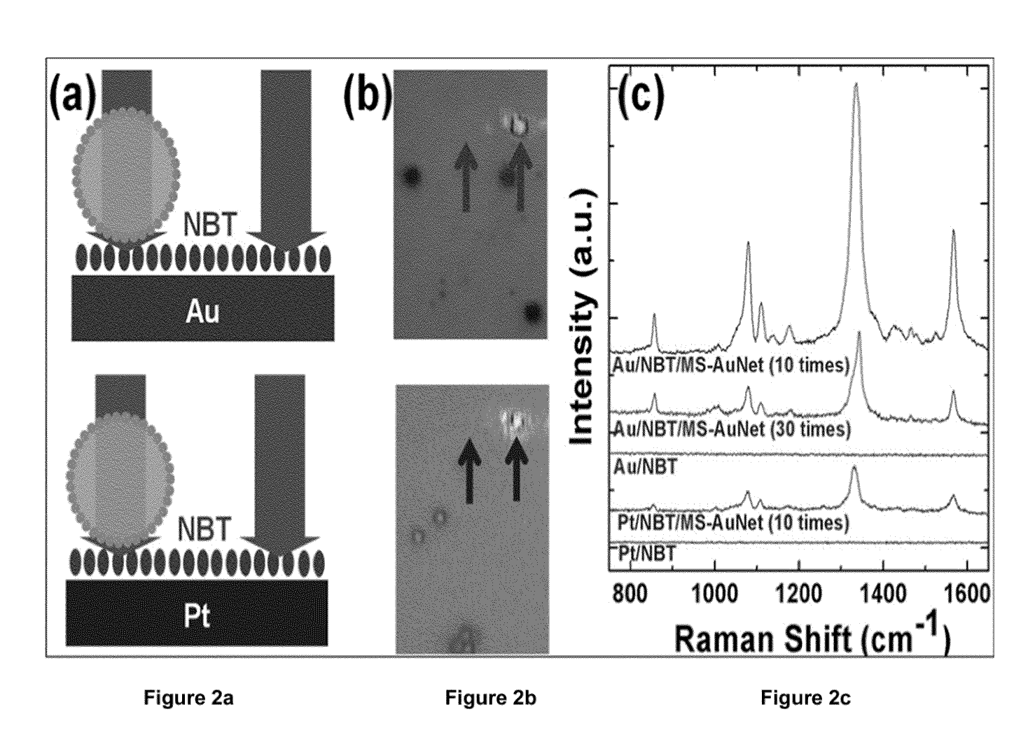

A bare single MS-AuNet placed on a monolayer of NBT on Au substrates also induces a SERS-active environment. The 10-times plated bare MS-AuNet provides not only a nano-gap effect but also hot spots on its own surface. The enhancement factor (EF) of SERS activity is estimated to be 2.5×10⁵. It produces significantly larger signals than those from a 30-times plated MS-AuNet with a completed Au layer providing only nano-gap effect as shown in FIG. 2. This indicates the effect of the hot spots on the surface of a MS-AuNet. For example, a single bare MS-AuNet can be also utilized to obtain SERS spectra of chemical species on Pt as well as Au. When a bare MS-AuNet is placed on a monolayer of NBT on Pt surfaces and the Raman laser is focused on a bare single MS-AuNet, SERS signals of NBT are observed as shown in FIG. 2 (c). The SERS enhancement induced by a MS-AuNet on Pt is smaller than on Au. The EF between a MS-AuNet and Pt surface is estimated to be 3.4×10⁴, which is an order of magnitude smaller than that on Au surfaces. However, considering that Pt is known to exhibit weak SERS activities, the SERS spectra in this system are strong and reproducible enough to chemically identify the organic monolayer on a Pt surface. It is notable that the signal enhancement by a MS-AuNet on Pt is higher than previously reported SERS systems based on Pt and requires neither special structures nor modification of the Pt surfaces on which an organic monolayer lies.

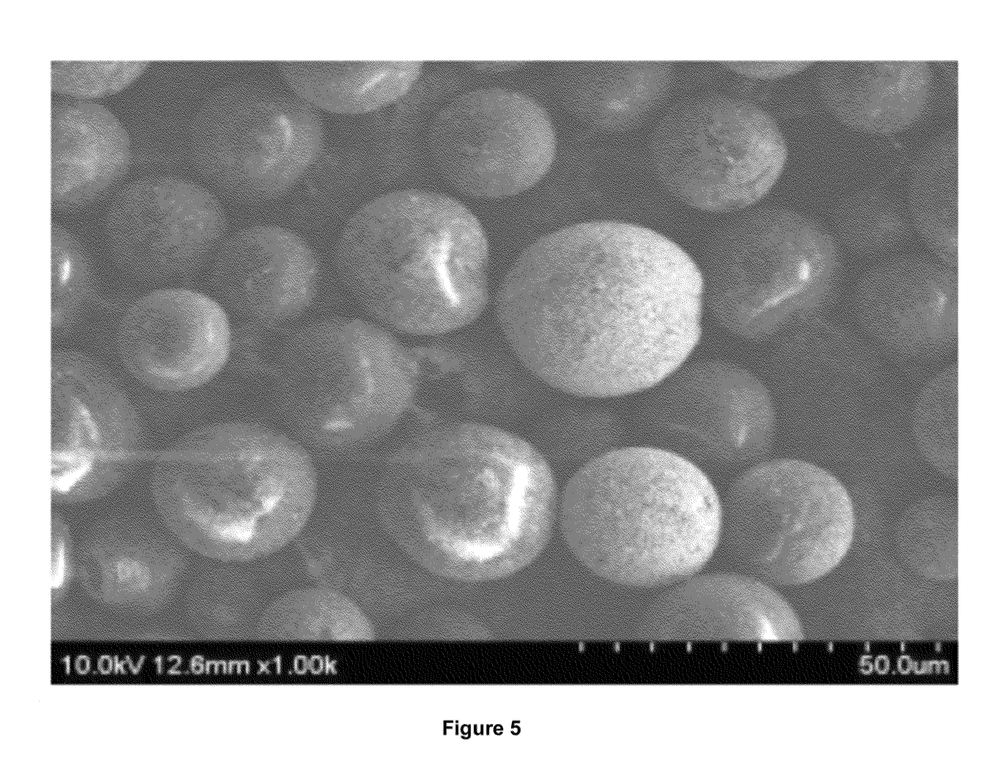

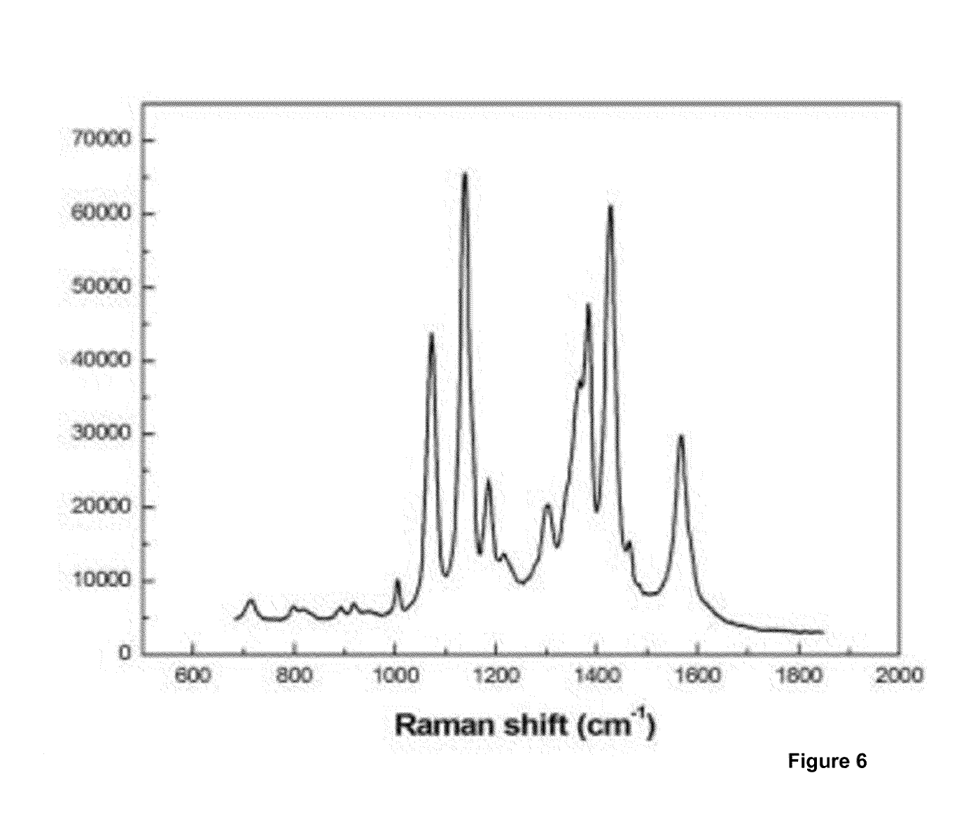

Microspheres having silver hot spots are prepared as another example for microspheres with metal network structures (MS-MeNet). FIG. 5 is the SEM image of microspheres with network structures of silver hot spots (MS-AgNets) and FIG. 6 shows the SERS spectrum of the above MS-AgNets which 4-aminebenzenethiol is adsorbed on. Microspheres having various sizes can be applied as a core for the production of microspheres as shown in FIG. 5. FIG. 6 shows that the peaks of 4-aminebenzenethiol is enhanced noticeably.

As shown in the above embodiments, the Au shell on a polymer microsphere may be tuned to achieve a strong SERS-active platform so that the molecules on entire or even only a part of a single MS-AuNet surface produce their own fingerprint SERS spectra. The proposed MS-AuNets can be identified and individually addressed using a conventional optical microscope. A single MS-AuNet may be used to act as a probe to obtain Raman spectra of monolayered molecules on Au and Pt surfaces by signal acquisition for about 1 ms, which is useful for decoding the microspheres with Raman tags flowing in a microfluidic system.

Using a typical micropipette or optical tweezers, a single MS-AuNet is placed on the spot of interest, trans-located to another spot and removed from the surface under the naked eye monitoring through an optical microscope. Since the SERS activity of a MS-AuNet is stable in water, this system can be utilized for in situ surface chemical probing in aqueous phase, which is useful for most of electro catalysis studies. The MS-AuNet in this work offers new ways for SERS-based probing techniques to a wide range of valuable applications such as a universal and reliable way of chemical identification with a high spatial resolution on surfaces, in vivo chemical or biological monitoring on the membrane of a living cell like neuron or stem cell, and high throughput decoding of microsphere suspension arrays in microfluidic systems.

We claim:

1. A device for probing Surface-Enhanced Raman Scattering activities, comprising:
a microsphere having hot spots, wherein surface of the microsphere is covered with metal networks.

2. The device of claim 1, wherein the metal network are formed with nano-sized pores that are randomly distributed on surface or in interstitial space of the metal networks.

3. The device of claim 1, wherein the metal networks are made of SERS-active metals.

4. The device of claim 3, wherein the metal networks are made of nanoparticles of SERS-active metals.

5. The device of claim 3, wherein the SERS-active metals include gold, platinum, silver, or copper.

6. The device of claim 1, wherein the microsphere is made of polymer, metal, silica, or magnetic material.

7. The device of claim 1, wherein size of the microspheres is in a range of 1 μm to 1000 μm.

8. The device of claim 1, wherein size of the microspheres is in a range of 1 μm to 100 μm.

9. The device of claim 1, wherein size of the microspheres is in a range of 1 μm to 30 μm.

10. The device of claim 2, wherein size of pores which are distributed on the surface or in the interstitial space of the metal networks is in a range of 1 nm to 30 nm.

11. The device of claim 2, wherein size of pores which are distributed on the surface or in the interstitial space of the metal networks is in a range of 1 nm to 20 nm.

12. The device of claim 2, wherein size of pores which are distributed on the surface or in the interstitial space of the metal networks is in a range of 1 nm to 10 nm.

13. The device of claim 1, wherein the metal networks are formed by nanoparticles having sizes in a range of 3 nm to 30 nm.

14. A method for identifying an analyte by Surface-Enhanced Raman Scattering, comprising:
contacting the analyte with a substrate;
adsorbing the analyte onto the substrate;
contacting the substrate with a microsphere, wherein the microsphere having hot spots and surface of the microsphere is covered with metal networks;
generating Surface-Enhanced Raman Scattering signals from the microsphere on the substrate;
collecting the Surface-Enhanced Raman Scattering signals; and
identifying the analyte using the Surface-Enhanced Raman Scattering signals.

15. The method of claim 14, wherein the substrate is made of SERS-active metals.

16. The method of claim 15, wherein the SERS-active metals include at least one of gold, platinum, silver, and copper.

17. A method for identifying an analyte by Surface-Enhanced Raman Scattering, comprising:
contacting the analyte with a microsphere, wherein the microsphere having hot spots and surface of the microsphere is covered with metal networks;
absorbing the analyte onto the microsphere;
generating Surface-Enhanced Raman Scattering signals from the microsphere;
collecting the Surface-Enhanced Raman Scattering signals; and
identifying the analyte using the Surface-Enhanced Raman Scattering signals.

18. The method of claim 17, wherein the metal network are formed with nano-sized pores that are randomly distributed on surface or in interstitial space of the metal networks.

19. The method of claim 17, wherein the metal networks are made of SERS-active metals.

20. The method of claim 19, wherein the SERS-active metals include at least one of gold, platinum, silver, and copper.
